(19) United States
(12) Patent Application Publication
(10) Pub. No.: US 2024/0347725 A1
(43) Pub. Date: Oct. 17, 2024

(54) CELL AND ELECTRONIC DEVICE

(71) Applicant: AESC Japan Ltd., Kanagawa (JP)

(72) Inventors: Yanglu Qu, Jiangsu (CN); Yonggang Xu, Jiangsu (CN); Yuhao Cao, Jiangsu (CN); Xiaobing Zhang, Jiangsu (CN)

(73) Assignee: AESC Japan Ltd., Kanagawa (JP)

(21) Appl. No.: 18/539,150

(22) Filed: Dec. 13, 2023

(30) Foreign Application Priority Data
Apr. 14, 2023 (CN) 202310407390.3

(51) Int. Cl. H01M 4/58; H01M 4/131; H01M 4/133; H01M 4/134; H01M 4/38; H01M 4/587

(52) U.S. Cl. CPC H01M 4/5825; H01M 4/131; H01M 4/133; H01M 4/134; H01M 4/386; H01M 4/587; H01M 2004/028

(57) ABSTRACT

In a cell and an electronic device, a first positive electrode film and a second positive electrode film are respectively arranged on two opposite surfaces of a positive electrode current collector. A gram capacity of a second positive electrode active substance is greater than a gram capacity of a first positive electrode active substance. A first negative electrode film and a second negative electrode film are arranged on two opposite surfaces of a negative electrode current collector. OI₂−OI₁>5, where OI₂ is an OI value of the second negative electrode film, and OI₁ is an OI value of the first negative electrode film. The positive electrode and the negative electrode in the cell are reasonably matched, which can maximize total energy density and capacity of the cell while also taking safety into account.

### CROSS-REFERENCE TO RELATED APPLICATION

This application claims the priority benefit of China application serial no. 202310407390.3, filed on Apr. 14, 2023. The entirety of the above-mentioned patent application is hereby incorporated by reference herein and made a part of this specification.

### BACKGROUND

### Technical Field

The disclosure relates to a cell and an electronic device.

### Related Art

In 2021, the sales of new energy vehicles in China exceeded 3.3 million units, and the annual total sales of the new energy market in China exceeded 5.5 million units in 2022, most of which adopted lithium-ion power batteries. Globally, there is a consensus on the rapid growth of new energy vehicles, and the development of lithium-ion batteries has entered a golden era.

In recent years, lithium-ion batteries have undergone rapid development, and most performance indicators have basically been improved meanwhile. Currently, energy density, safety, and costs are the main issues of concern to major cell suppliers.

However, the weight energy density of conventional lithium iron phosphate power cells is generally 160 to 190 Wh/kg. Having a similar structure and energy storage mechanism to lithium iron phosphate, lithium manganese iron phosphate has a theoretical capacity comparable to lithium iron phosphate and has a higher voltage platform and can thus provide higher energy density, but it is still difficult to exceed 200 Wh/kg. Although the energy density of ternary lithium-ion batteries is higher, their high price and thermal safety make consumers somewhat hesitant. Thus, the industry chooses to use phosphate positive electrode materials together with high energy density positive electrode materials such as ternary positive electrodes, lithium-rich manganese-based positive electrodes, etc.

Common phosphate positive electrodes and ternary materials are used by mixing internally in a slurry. Since phosphate has poor conductivity, more conductive agent is required. Also, the specific surface area is large, so more binder is required. As a result, the proportion of the main material in the electrode plate is low, which affects the total energy density of the cell. At the same time, phosphate positive electrode materials with low ionic conductivity and electronic conductivity may adsorb on the surface of ternary materials, which affects the capacity performance of the ternary materials.

Moreover, materials such as lithium iron phosphate, lithium manganese iron phosphate, ternary positive electrode materials, and lithium-rich manganese-based materials each have more matching negative electrode graphite materials. If a mixed positive electrode is used, it will pose new challenges to the selection of graphite.

### SUMMARY

To address the difficulty in matching the positive electrode material and the negative electrode material in the secondary battery in the related art and its impact on the total energy density and capacity performance of the cell, the disclosure provides a cell and an electronic device. The positive electrode and the negative electrode in the cell of the disclosure are reasonably matched, which can maximize the performances of total energy density and capacity of the cell while taking safety into account.

The disclosure addresses the above technical problems mainly by the following technical solutions.

According to a first aspect, the disclosure provides a cell including a positive electrode plate and a negative electrode plate alternately arranged along a cell thickness direction, with a separator provided between the positive electrode plate and the negative electrode plate. The positive electrode plate includes a positive electrode current collector, a first positive electrode film, and a second positive electrode film, and the first positive electrode film and the second positive electrode film are respectively arranged on two opposite surfaces of the positive electrode current collector. The first positive electrode film includes a first positive electrode active substance that includes a phosphate material, the second positive electrode film includes a second positive electrode active substance that has a gram capacity greater than a gram capacity of the first positive electrode active substance. The negative electrode plate includes a negative electrode current collector, a first negative electrode film, and a second negative electrode film, and the first negative electrode film and the second negative electrode film are respectively arranged on two opposite surfaces of the negative electrode current collector. The first negative electrode film includes a first negative electrode active substance, the second negative electrode film includes a second negative electrode active substance, and OI₂−OI₁>5 is satisfied, where OI₂ is an OI value of the second negative electrode film, and OI₁ is an OI value of the first negative electrode film.

According to a second aspect, the disclosure further provides an electronic device including the cell described above.

The positive progressive effects of the disclosure are as follows. The disclosure selects different positive electrode formulations for different negative electrode formulations to maximize matching in the mixing system and achieve a combination of high energy density, high safety, and low costs.

### BRIEF DESCRIPTION OF DRAWINGS

FIG. 1 is a schematic structure diagram of a cell prepared in Example 1 to Example 2 of the disclosure. (1: negative electrode current collector; 2: positive electrode current collector; 4: second positive electrode film; 5: first positive electrode film; 6: second negative electrode film; 7: first negative electrode film.)

FIG. 2 is a simplified structure diagram of the cell prepared in Example 1 to Example 2 of the disclosure. (1: negative electrode current collector; 2: positive electrode current collector; 3: separator; 4: second positive electrode film; 5: first positive electrode film; 6: second negative electrode film; 7: first negative electrode film.)

### DESCRIPTION OF EMBODIMENTS

In the following text, the disclosure will be described in more detail to better understand the disclosure. It should be understood that the words or terms used in this specification and the claims should not be interpreted as having the meanings defined in common dictionaries. It should be further understood that the words or terms should be interpreted as having meanings consistent with their meanings in the relevant technical context and the technical concept of the disclosure, based on the principle that the inventors may appropriately define the meanings of the words or terms to best interpret the disclosure.

### Cell

In the cell according to the first aspect of the disclosure:

The two surfaces of the positive electrode respectively adopt a phosphate material and a high density active substance, which respectively correspond in a one-to-one manner to a high energy density film and a fast charging high kinetics film of the negative electrode. The positive and negative electrodes match each other to achieve a balance between energy density and fast charging performance.

### Positive Electrode Plate

In the disclosure, the first positive electrode film is adjacent to the second negative electrode film via a separator, and the second positive electrode film is adjacent to the first negative electrode film via a separator.

In the disclosure, as the first positive electrode active substance, the phosphate material may be a positive electrode phosphate material commonly used in this field, preferably lithium iron phosphate and/or lithium manganese iron phosphate. The use of the phosphate material can reduce the system cost and improve safety performance.

Preferably, based on the mass of the first positive electrode film, the mass content of the phosphate material is 92% to 97%, for example, 94% or 95%.

Preferably, the discharge gram capacity of the phosphate material at a current density of 0.1 C is 160 mAh/g or below, more preferably 127 to 160 mAh/g, for example, 141 mAh/g or 157 mAh/g.

In the disclosure, the second positive electrode active substance is a high energy density active substance commonly used in this field, and its use can enhance the energy density and low temperature cycling performance of the battery.

Preferably, the second positive electrode active substance includes one or more of lithium manganate, lithium cobalt oxide, lithium nickelate, lithium nickel cobalt aluminum oxide, lithium nickel cobalt manganese oxide, and lithium-rich manganese-based materials.

When the second positive electrode active substance includes lithium nickel cobalt aluminum oxide or lithium nickel cobalt manganese oxide, in the lithium nickel cobalt aluminum oxide or lithium nickel cobalt manganese oxide, based on the mass of the lithium nickel cobalt aluminum oxide or lithium nickel cobalt manganese oxide, the mass content of Ni is 60% or more.

Preferably, based on the mass of the second positive electrode film, the content of the second positive electrode active substance is 94% to 98%, for example, 96%.

Preferably, the discharge gram capacity of the second positive electrode active substance at a current density of 0.1 C is 180 mAh/g or more, more preferably 180 to 210 mAh/g, for example, 198 mAh/g.

In some preferred embodiments, the content of the second positive electrode active substance is greater than the content of the first positive electrode active substance.

In some preferred embodiments, the first positive electrode active substance is lithium manganese iron phosphate, and the second positive electrode active substance is lithium nickel cobalt manganese oxide.

The lithium manganese iron phosphate is preferably LiMn_{0.6}Fe_{0.4}PO₄, and the lithium nickel cobalt manganese oxide is preferably LiNi_{0.8}Co_{0.1}Mn_{0.1}O₂.

In some preferred embodiments, the first positive electrode active substance is lithium iron phosphate, and the second positive electrode active substance is lithium nickel cobalt manganese oxide.

The lithium iron phosphate is preferably LiFePO₄, and the lithium nickel cobalt manganese oxide is preferably LiNi_{0.8}Co_{0.1}Mn_{0.1}O₂.

In the disclosure, the thickness ratio of the first positive electrode film to the second positive electrode film is preferably (1.1 to 2.5), for example, 1.98:1 or 1.63:1.

In the disclosure, the thickness of the first positive electrode film may be 50 to 120 μm, preferably 60 to 100 μm, for example, 76 μm or 91 μm.

In the disclosure, the thickness of the second positive electrode film may be 30 to 90 μm, preferably 40 to 70 μm, for example, 47 μm.

In the disclosure, positive electrode active substances of different capacities are selected, which require negative electrode materials with matching capacities. When an appropriate thickness ratio is selected, it is possible to control the thickness difference between the front and back surfaces of the negative electrode to be small, which is beneficial for the processing of the negative electrode.

The thickness described in the disclosure is calculated according to the following method.

Let the thickness of the first positive electrode film be h₁, the specific discharge capacity of the first positive electrode film be x₁, and the specific discharge capacity of the second negative electrode film be x₂; the proportion of the first positive electrode active substance be y₁, the proportion of the second negative electrode active substance be y₂, the compacted density of the first positive electrode film after rolling be z₁, and the compacted density of the second negative electrode film after rolling be z₂; and N/P be a₁. Then, the thickness h₂ of the second negative electrode film is

$$\frac{{a}_{1} \times {x}_{1} \times {y}_{1} \times {z}_{1} \times {h}_{1}}{{x}_{2} \times {y}_{2} \times {z}_{2}} .$$

Let the thickness of the second positive electrode film be h₃, the specific discharge capacity of the second positive electrode film be x₃, and the specific discharge capacity of the first negative electrode film be x₄; the proportion of the second positive electrode active substance be y₃, the proportion of the first negative electrode active substance be y₄, the compacted density of the second positive electrode film after rolling be z₃, and the compacted density of the first electrode film after rolling be z4; and N/P be a2. Then the thickness h4 of the first negative electrode film is

$$\frac{{a}_{2} \times {x}_{2} \times {y}_{2} \times {z}_{2} \times {h}_{a}}{{x}_{4} \times {y}_{4} \times {z}_{4}} .$$

N/P may be 1.02 to 1.14, and a₁≥a₂. The N/P, which stands for negative/positive, is “capacity of negative electrode per unit area/capacity of positive electrode per unit area”, and is generally a ratio of charging capacity.

z₃>z₁, and z₃−z₁>0.4 g/cm³. Since it is required to design a constant pressure and roll gap width in the rolling process of the positive electrode film, the compacted density z₁ of the first positive electrode film and the compacted density z₃ of the second positive electrode film are different.

In some specific embodiments, the thickness of the first positive electrode film is 50 to 120 μm; the compacted density of the first positive electrode film is 2.2 to 2.6 g/cm³; the thickness of the second positive electrode film is 30 to 90 μm; and the compacted density of the second positive electrode film is 3.3 to 3.7 g/cm³.

In the disclosure, the first positive electrode film generally further includes a first positive electrode conductive agent, a first positive electrode binder, and a first positive electrode dispersant; and the second positive electrode film generally further includes a second positive electrode conductive agent, a second positive electrode binder, and a second positive electrode dispersant.

There are no specific restrictions on the first positive electrode conductive agent and the second positive electrode conductive agent, as long as they are conductive and do not cause chemical changes in the battery. Specific examples include: graphite, such as natural graphite or artificial graphite; carbon-based materials, such as carbon black, acetylene black, Ketjen black, channel black, furnace black, lamp black, thermal carbon black, and carbon fibers; metal powders or metal fibers, such as copper, nickel, aluminum, and silver; conductive whiskers, such as zinc oxide whiskers and potassium titanate whiskers; conductive metal oxides, such as titanium dioxide; or conductive polymers, such as polyphenylene derivatives, etc.

In the first positive electrode film, the content of the first conductive agent is preferably 1% to 3%, for example, 2%, where the percentage is the percentage of the mass of the first conductive agent in the mass of the first positive electrode film.

In the second positive electrode film, the mass ratio of the second conductive agent is preferably 0.5% to 2%, for example, 1.5%, where the percentage is the percentage of the mass of the second conductive agent in the mass of the second positive electrode film.

The first positive electrode binder and the second positive electrode binder serve to enhance the binding between the positive electrode active substance particles and the adhesion between the positive electrode active substance and the positive electrode current collector. There are no specific restrictions on their types, and specific examples of the binders may include polyvinylidene fluoride (PVDF), polyvinylidene fluoride-co-hexafluoropropylene (PVDF-co-HFP), polyvinyl alcohol, polyacrylonitrile, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene rubber (SBR), fluororubber, or various copolymers thereof, and any one or a mixture of two or more of the above may be used.

In the first positive electrode film, the content of the first binder is preferably 1.5% to 4%, for example, 3.5%, where the percentage is the percentage of the mass of the first binder in the mass of the first positive electrode film. An increase in the proportions of the conductive agent and the binder in the first positive electrode film can enhance the electrochemical performance of the phosphate material.

In the second positive electrode film, the mass ratio of the second binder is preferably 0.5% to 2%, where the percentage is the percentage of the mass of the second binder in the mass of the second positive electrode film.

Preferably, the content of the second positive electrode binder is lower than the content of the first positive electrode binder.

The first dispersant and the second dispersant may be substances commonly used in this field to improve dispersion uniformity of the active substances.

In the first positive electrode film, the content of the first dispersant may be 0 to 1%, where the percentage is the percentage of the mass of the first dispersant in the mass of the first positive electrode film.

In the second positive electrode film, the content of the second dispersant may be 0 to 1%, where the percentage is the percentage of the mass of the second dispersant in the mass of the second positive electrode film.

In the disclosure, the method for preparing the positive electrode plate includes the following steps: coating the raw material mixture of the first positive electrode film and the raw material mixture of the second positive electrode film respectively on two surfaces of the positive electrode current collector to obtain the positive electrode plate.

In the disclosure, the surface density generally refers to the mass of the raw material mixture coated per unit area, and refers to one surface.

In some specific embodiments of the disclosure, the surface densities of the first positive electrode film and the second positive electrode film may be 15 to 32 mg/cm², preferably 20 to 25 mg/cm², for example, 22 mg/cm².

In some preferred embodiments, the surface density of the second positive electrode film is less than the surface density of the first positive electrode film.

In some preferred embodiments, the surface density of the raw material composition of the second positive electrode film during coating is 60% to 95% of the surface density of the raw material composition of the first positive electrode film during coating.

### Negative Electrode Plate

In the disclosure, the OI value refers to the degree of orientation, which may be calculated based on data measured by XRD. The OI value is a ratio of the peak area of the 004 characteristic peak in the X-ray diffraction spectrum of the negative electrode film to the peak area of the 110 characteristic peak in the X-ray diffraction spectrum of the negative electrode film.

In the disclosure, OI₁=C₀₀₄/C₁₁₀, where C₀₀₄ is the peak area of the 004 characteristic diffraction peak in the X-ray diffraction spectrum of the first negative electrode film; and C₁₁₀ is the peak area of the 110 characteristic diffraction peak in the X-ray diffraction spectrum of the first negative electrode film.

OI₂=C′₀₀₄/C′₁₁₀, where C′₀₀₄ is the peak area of the 004 characteristic diffraction peak in the X-ray diffraction spectrum of the second negative electrode film; and C′₁₁₀ is the peak area of the 110 characteristic diffraction peak in the X-ray diffraction spectrum of the second negative electrode film.

In the disclosure, XRD is measured with Bruker D8A25 X-ray diffractometer.

The magnitude of the OI value of the negative electrode film may reflect the degree of stacking orientation of the negative electrode active material particles in the negative electrode film, which directly affects the expansion of the negative electrode plate in the cycling process. In the charging process, lithium ions are de-intercalated from the positive electrode active substance and intercalated in the negative electrode active substance, so the OI value of the negative electrode film has a great impact on the charging speed and cycle life of the lithium-ion battery.

When the difference between OI₂ and OI₁ is greater than 5, the high energy and high kinetics characteristics of the different active substances on two surfaces of the negative electrode plate can be fully utilized. Specifically, the high energy active substance has advantages of high gram capacity and high degree of orientation and can contribute to higher energy density. In the related art, active substances with high OI and low OI are mixed and used together, but the mixture of low OI value with high OI generally fails to create excellent rate capability and high kinetics performance. In the disclosure, active substances with high OI and low OI values are respectively coated on two opposite surfaces of the negative electrode current collector, which can balance the combination of high kinetics and energy density.

In some specific embodiments, the OI value OI₁ of the first negative electrode film is 2 to 15, preferably 4 to 10.

In some specific embodiments, the OI value OI₂ in the second negative electrode film is 15 to 50, preferably 15 to 40.

In some preferred embodiments, the OI₂−OI₁ is 5 to 15, for example, 12 or 14.

In the disclosure, the first negative electrode active substance and the second negative electrode active substance may each independently include one or two of graphite and silicon materials. The graphite includes natural graphite or artificial graphite; and the silicon materials include at least one of silicon-carbon material or carbon-silicon-oxygen material.

It can be understood that the silicon-carbon material refers to a material that contains both silicon element and carbon element. Exemplarily, the silicon-carbon material has a structure in which silicon nanocrystal particles are filled in pores of a carbon skeleton. It can be understood that the silicon-oxygen-carbon material refers to a material that contains silicon element, oxygen element, and carbon element at the same time. Exemplarily, the silicon-oxygen-carbon material has as structure in which silicon nanocrystal particles are dispersed in a silicon dioxide matrix to form a composite, and elemental carbon is wrapped on the outer surface of the composite.

In the disclosure, based on the mass of the first negative electrode film, the mass content of the first negative electrode active substance is 93 to 98%, for example, 96%.

In the disclosure, based on the mass of the first negative electrode film, the first negative electrode film may further include 0.2 to 1.5% of a first negative electrode conductive agent, 1 to 3% of a first negative electrode binder, and 0.01 to 1.5% of a first negative electrode dispersant.

In the disclosure, based on the mass of the second negative electrode film, the mass content of the second negative electrode active substance is preferably 95 to 98.5%, for example, 95%.

In some specific embodiments, the types of the first negative electrode active substance and the second negative electrode active substance are the same as each other, and the mass content of the first negative electrode active substance is lower than the mass content of the second negative electrode active substance. When the mass contents of the first negative electrode active substance and the second negative electrode active substance satisfy the above conditions, the capacity retention rate of the battery can be effectively improved.

In the disclosure, based on the mass of the second negative electrode film, the second negative electrode film may further include 0.2 to 1.5% of a second negative electrode conductive agent, 0.5 to 2% of a second negative electrode binder, and 0.01 to 1.5% of a second negative electrode dispersant.

The first negative electrode conductive agent and the second negative electrode conductive agent are reagents used to ensure that the electrode has good charge and discharge performance. They may be selected from any of graphite materials such as natural graphite and artificial graphite, carbon black materials such as carbon black, acetylene black, Ketjen black, channel black, furnace black, lamp black, and thermal carbon black, conductive fibers such as carbon fibers and metal fibers, metal powders such as fluorocarbon powder, aluminum powder, and nickel powder, conductive whiskers such as zinc oxide, potassium titanate, and conductive metal oxides such as titanium dioxide, or polyphenylene derivatives.

The first negative electrode binder and the second negative electrode binder are components that contribute to binding between the active substance and the conductive agent and contribute to combination of the active substance with the current collector. They may generally be selected from polyvinylidene difluoride, polyvinyl alcohol, carboxymethyl cellulose (CMC), starch, hydroxypropyl cellulose, regenerated cellulose, polyvinylpyrrolidone, polyacrylic acid (PAA), tetrafluoroethylene, polyethylene, polypropylene, ethylene-propylene-diene terpolymer (EPDM), sulfonated EPDM, styrene-butadiene rubber (SBR), fluororubber, and various copolymers.

In the disclosure, the thickness of the first negative electrode film and the thickness of the second negative electrode film may be the same as or different from each other.

In some specific embodiments, the compacted density of the second negative electrode film is greater than that of the first negative electrode film.

In some specific embodiments, the gram capacity of the second negative electrode film is greater than that of the first negative electrode film.

In some specific embodiments, the thickness of the second negative electrode film is slightly greater than that of the first negative electrode film.

In the disclosure, the thickness of the first negative electrode film may be 50 to 100 μm, preferably 50 to 60 μm, for example, 52 μm.

In the disclosure, the thickness of the second negative electrode film may be 50 to 100 m, preferably 50 to 60 μm, for example, 54 μm.

In some specific embodiments, the first positive electrode active substance is lithium manganese iron phosphate, the second positive electrode active substance is lithium nickel cobalt manganese oxide, the first negative electrode active substance is artificial graphite, and the second negative electrode active substance is artificial graphite, where OI₂−OI₁ is 10.

In some more specific embodiments, the first positive electrode active substance is lithium manganese iron phosphate, the thickness of the first positive electrode film is 91 μm, the second positive electrode active substance is lithium nickel cobalt manganese oxide, and the thickness of the second positive electrode film is 47 μm; the first negative electrode active substance is artificial graphite, the thickness of the first negative electrode film is 52 μm, the second negative electrode active substance is artificial graphite, the thickness of the second negative electrode film is 54 jam, and OI₂−OI₁ is 10.

In some specific embodiments, the first positive electrode active substance is lithium iron phosphate, the second positive electrode active substance is lithium nickel cobalt manganese oxide, the first negative electrode active substance is artificial graphite, and the second negative electrode active substance is artificial graphite, where OI₂−OI₁ is 12.

In some more specific embodiments, the first positive electrode active substance is lithium iron phosphate, the thickness of the first positive electrode film is 76 μm, the second positive electrode active substance is lithium nickel cobalt manganese oxide, and the thickness of the second positive electrode film is 47 μm; the first negative electrode active substance is artificial graphite, the thickness of the first negative electrode film is 52 μm, the second negative electrode active substance is artificial graphite, the thickness of the second negative electrode film is 54 μm, and OI₂−OI₁ is 12.

In some specific embodiments of the disclosure, the surface densities of the first negative electrode film and the second negative electrode film may be 7 to 20 mg/cm², preferably 8 to 12 mg/cm², for example, 10 mg/cm².

In the disclosure, the method for preparing the negative electrode plate includes the following steps: coating the raw material mixture of the first negative electrode film and the raw material mixture of the second negative electrode film respectively on the two opposite surfaces of the negative electrode current collector to obtain the negative electrode plate.

In the disclosure, the method for preparing the cell may adopt conventional methods in this field, and generally include the following steps: after rolling and slitting the positive electrode plate and the negative electrode plate, successively stacking the positive electrode plate, the separator, and the negative electrode plate by cutting, stacking, or winding processes to form a cell.

### Electronic Device

The electronic device according to the third aspect of the disclosure includes the cell described above.

Exemplarily, the electronic device of the disclosure may be, but is not limited to, a mobile device (e.g., a mobile phone, a tablet computer, a laptop, a camcorder, a portable printer/copier, etc.), an electric vehicle (e.g., a pure electric car, a hybrid electric car, a plug-in hybrid electric car, an electric bicycle, an electric scooter, an electric golf cart, an electric truck, etc.), an electric train, a ship and a satellite, an energy storage system, a backup power supply, etc.

Based on the common knowledge in this field, the above preferred conditions may be combined in any manner to obtain the better examples of the disclosure. The disclosure will be further illustrated based on the following examples, but the disclosure is not thus limited to the scope of the described examples. Any experimental methods in the following examples for which specific conditions are not described may be selected according to conventional methods and conditions or according to product instruction manuals.

### Example 1

### (1) Preparation of Positive Electrode Plate:

Preparation of raw material mixture A₁ of first positive electrode film: A mixture of lithium manganese iron phosphate (LiMn_{0.6}Fe_{0.4}PO₄), a conductive agent SP, and a binder PVDF with a mass ratio of 95.5:2:2.5 was fully stirred in a stirrer, and then a solvent N-methylpyrrolidone was added at a solid content of 55% and stirred and uniformly mixed to prepare a first positive electrode slurry A1. The discharge gram capacity of LiMn_{0.6}Fe_{0.4}PO₄ at a current density of 0.1 C was 141 mAh/g.

Preparation of raw material mixture A₂ of second positive electrode film: A mixture of LiNi_{0.8}Co_{0.1}Mn_{0.1}O₂, a conductive agent SP, and a binder PVDF with a mass ratio of 97:1.5:1.5 was fully stirred in a stirrer, and then a solvent N-methylpyrrolidone was added at a solid content of 60% and stirred and uniformly mixed to prepare a second positive electrode slurry A₂. The discharge gram capacity of LiNi_{0.8}Co_{0.1}Mn_{0.1}O₂ at a current density of 0.1 C was 198 mAh/g.

The raw material mixture A₁ of the first positive electrode film and the raw material mixture A₂ of the second positive electrode film were uniformly coated on the current collector at a surface density of 22 mg/cm², and then treated with a coating drying machine to prepare a positive electrode plate of a specified size.

### (2) Preparation of Negative Electrode Plate

Preparation of raw material mixture B₁ of the first negative electrode film: A mixture of artificial graphite, a conductive agent SP, a binder SBR+PAA, and a dispersant CMC with a mass ratio of 96:1:2:1 was fully stirred in a stirrer, and then a solvent N-methylpyrrolidone or deionized water was added at a solid content of 58% and stirred and uniformly mixed to prepare a first negative electrode slurry B₁.

Preparation of raw material mixture B₂ of second negative electrode film: A mixture of artificial graphite, a conductive agent SP, a binder SBR+PAA, and a dispersant CMC with a mass ratio of 95:1.5:2.5:1 was fully stirred in a stirrer, and then a solvent N-methylpyrrolidone or deionized water was added at a solid content of 56% and stirred and uniformly mixed to prepare a second negative electrode slurry B₂.

The raw material mixture B₁ of the first negative electrode film and the raw material mixture B₂ of the second negative electrode film were uniformly coated on two surfaces of the current collector at a surface density of 10 mg/cm² to prepare a first negative electrode film and a second negative electrode film, which was then treated with a coating drying machine to prepare a negative electrode plate of a specified size. The degree of orientation OI₁ of the first negative electrode film was 8, and the degree of orientation OI₂ of the second negative electrode film was 18.

### (3) Preparing Electrolytic Solution:

The organic solvent was a mixture of ethylene carbonate (EC), ethyl methyl carbonate (EMC), and diethyl carbonate (DEC), where the volume ratio of EC, EMC, and DEC was 20:20:60. In an argon atmosphere glove box with a moisture content of <10 ppm, a thoroughly dried lithium salt (LiPF₆) was dissolved in the organic solvent described above, and after mixing uniformly, an electrolytic solution was obtained, where the concentration of LiPF₆ was 1 mol/L.

### (4) Preparing Separator:

A polypropylene separator with a thickness of 12 μm was selected.

### (5) Assembly of Cell and Lithium-Ion Battery:

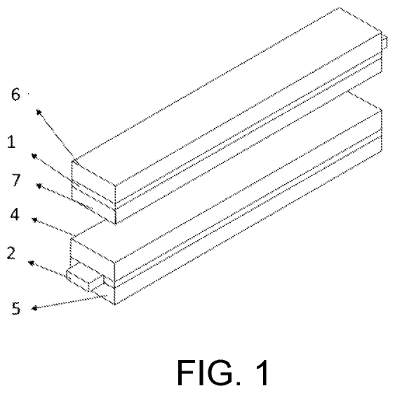

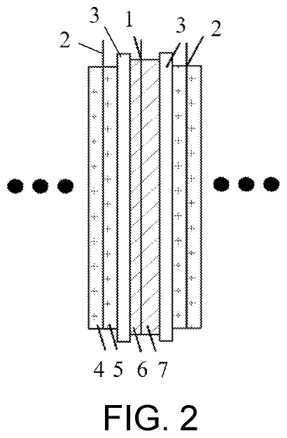

The positive electrode plate, the negative electrode plate, and the separator were subjected to rolling-slitting and cutting-stacking to prepare a cell. The bare cell JR was then placed in a shell, was thoroughly baked such that the moisture content was 450 ppm or below, and then was subjected to processes including electrolyte injection, battery formation, sealing, and inspection to prepare a square hard-shell lithium-ion battery. The structure of the assembled cell is shown in FIG. 1 and FIG. 2, in which the two opposite surfaces of the negative electrode current collector 1 are respectively provided with the first negative electrode film 7 and the second negative electrode film 6, the two opposite surfaces of the positive electrode current collector 2 are respectively provided with the first positive electrode film 5 and the second positive electrode film 4, the first positive electrode film 5 and the second negative electrode film 6 are adjacent via the separator 3, and the second positive electrode film 4 and the first negative electrode film 7 are adjacent via the separator 3.

### Example 2

The first positive electrode active substance in the raw material mixture of the first positive electrode film was replaced with lithium iron phosphate (LiFePO₄), where the discharge gram capacity of LiFePO₄ at a current density of 0.1 C was 157 mAh/g.

The degree of orientation OI of the first negative electrode film was 8, and the degree of orientation OI of the second negative electrode film was 20.

The other formulation components and preparation methods were the same as in Example 1.

### Comparative Example 1

Both the first positive electrode film and the second positive electrode film in the positive electrode plate were prepared by coating the raw material mixture A₁ of the first positive electrode film in Example 1.

Both the first negative electrode film and the second negative electrode film of the negative electrode plate were prepared by coating the raw material mixture B₂ of the second negative electrode film in Example 1, where the degrees of orientation OI of both the first negative electrode film and the second negative electrode film were 18.

The other formulation components and preparation methods were the same as in Example 1.

### Comparative Example 2

Both the first positive electrode film and the second positive electrode film in the positive electrode plate were prepared by coating the raw material mixture A₂ of the second positive electrode film in Example 1.

Both the first negative electrode film and the second negative electrode film of the negative electrode plate were prepared by coating the raw material mixture B₁ of the first negative electrode film in Example 1, where the degrees of orientation OI of both the first negative electrode film and the second negative electrode film were 8.

The other formulation components and preparation methods were the same as in Example 1.

### Comparative Example 3

The first negative electrode film was prepared by coating the raw material mixture B₂ of the second negative electrode film in Example 1; and the second negative electrode film was prepared by coating the raw material mixture B₁ of the first negative electrode film in Example 1, where the degree of orientation OI of the first negative electrode film was 18, and the degree of orientation OI of the second negative electrode film was 8.

The other formulation components and preparation methods were the same as in Example 1.

### Comparative Example 4

The first negative electrode film was prepared by coating the raw material mixture B₂ of the second negative electrode film in Example 1, and the degree of orientation OI of the first negative electrode film was 18.

The degree of orientation OI of the second negative electrode film was 20.

The other formulation components and preparation methods were the same as in Example 1.

### Comparative Example 5

Both the first positive electrode film and the second positive electrode film in the positive electrode plate were prepared by coating the raw material mixture A₁ of the first positive electrode film in Example 1.

The degree of orientation OI of the first negative electrode film was 18; and the degree of orientation OI of the second negative electrode film was 7.

The other formulation components and preparation methods were the same as in Example 1.

### Comparative Example 6

Both the first negative electrode film and the second negative electrode film in the negative electrode plate were prepared by coating the raw material mixture B₂ of the second negative electrode film in Example 1, where the degrees of orientation OI of both the first negative electrode film and the second negative electrode film were 18.

The rest was the same as in Example 1.

The film thicknesses of Example 1 to Example 2 and Comparative Example 1 to Comparative Example 6 are shown in Table 1.

TABLE 1

| | Thickness | Thickness | Thickness | Thickness |
|---|---|---|---|---|
| | of first | of second | of first | of second |
| | positive | positive | negative | negative |
| | electrode | electrode | electrode | electrode |
| | film (μm) | film (μm) | film (μm) | film (μm) |
| Example 1 | 91 | 47 | 52 | 54 |
| Example 2 | 76 | 47 | 52 | 54 |
| Comparative | 91 | 91 | 52 | 52 |
| Example 1 | | | | |
| Comparative | 47 | 47 | 54 | 54 |
| Example 2 | | | | |
| Comparative | 91 | 47 | 54 | 52 |
| Example 3 | | | | |
| Comparative | 91 | 47 | 52 | 52 |
| Example 4 | | | | |
| Comparative | 91 | 91 | 52 | 55 |
| Example 5 | | | | |
| Comparative | 91 | 91 | 52 | 52 |
| Example 6 | | | | |

### Verification Example 1

Capacity retention rates of the batteries prepared from Example 1 to Example 2 and Comparative Example 1 to Comparative Example 6 were tested after 0 to 1000 cycles under the condition of a charging or discharging voltage of 1 C at 45° C. The results are shown in Table 2.

TABLE 2
Capacity retention rate

| Number | | | Compara- | Compara- | Compara- | Compara- | Compara- | Compara- |
|---|---|---|---|---|---|---|---|---|
| of | Example | Example | tive | tive | tive | tive | tive | tive |
| cycles | 1 | 2 | Example 1 | Example 2 | Example 3 | Example 4 | Example 5 | Example 6 |
| 0 | 100% | 100% | 100% | 100% | 100% | 100% | 100% | 100% |
| 100 | 99.95% | 99.20% | 98.19% | 98.54% | 99.0% | 99.1% | 99.75% | 99.65% |
| 200 | 98.67% | 98.66% | 97.50% | 96.09% | 98.1% | 98.3% | 98.5% | 98.32% |
| 300 | 97.46% | 97.32% | 96.78% | 94.40% | 97.0% | 97.1% | 97.5% | 97.01% |
| 500 | 94.35% | 95.04% | 95.67% | 92.01% | 94.6% | 94.8% | 94.3% | 93.75% |
| 700 | 92.26% | 92.83% | 93.71% | 89.09% | 92.4% | 92.6% | 91.9% | 91.01% |
| 1000 | 90.32% | 90.57% | 91.85% | 85.22% | 89.1% | 90.1% | 89.5% | 87.62% |

TABLE 3

| | | | Compara- | Compara- | Compara- | Compara- | Compara- | Compara- |
|---|---|---|---|---|---|---|---|---|
| | Example | Example | tive | tive | tive | tive | tive | tive |
| | 1 | 2 | Example 1 | Example 2 | Example 3 | Example 4 | Example 5 | Example 6 |
| Energy | 246 | 239 | 193 | 273 | 243 | 248 | 191 | 244 |
| density | | | | | | | | |
| (wh/kg) | | | | | | | | |

As can be learned from Table 2 and Table 3, the disclosure reasonably matches the positive electrode materials and the negative electrode materials. Under these matching conditions, the batteries prepared from Example 1 and Example 2 have advantages of high energy density and good cycling performance. Specifically, the energy density can reach 246 wh/kg or more, and the capacity retention rate after 1000 cycles can be 90.32% or even more.

Comparing Example 1 and Comparative Example 1, Comparative Example 1 adopted the same first positive electrode film and second positive electrode film, both of which were phosphate positive electrodes, and adopted the same first negative electrode film and second negative electrode film, both of which were negative electrodes with high 01 values. It can be learned that although it had a capacity retention rate comparable to that of Example 1, its energy density was lower than that of Example 1 and was only 193 wh/kg.

Comparing Example 1 and Comparative Example 2, Comparative Example 2 adopted the same first positive electrode film and second positive electrode film, both of which were 8-series high-nickel ternary positive electrodes, and adopted the same first negative electrode film and second negative electrode film, both of which were negative electrodes with low OI values. It can be learned that although it retained the high energy density characteristic of the positive electrode material, its capacity retention rate after 1000 cycles was only 85.22%, which was lower than that of Example 1.

Comparing Example 1 and Comparative Example 3, in Comparative Example 3, the first negative electrode film (low OI value) was adjacent to the first positive electrode film, and the second negative electrode film (high OI value) was adjacent to the second positive electrode film. Although its energy density was comparable to that of Example 1, its cycling stability was lower than that of Example 1.

Comparing Example 1 and Comparative Example 4, in Comparative Example 4, both the first negative electrode film and the second negative electrode film adopted negative electrode materials with high OI values, and the difference of OI₂−OI₁ was 2. As a result, its capacity retention rate after 1000 cycles was 90.1%, and the energy density was 248 wh/kg.

Comparing Example 1 and Comparative Example 5, in Comparative Example 5, both the first positive electrode film and the second positive electrode film adopted the same phosphate positive electrode material. Its energy density was only 191 wh/kg, and its capacity retention rate after 1000 cycles was only 89.5%, both of which were lower than those of Example 1.

Comparing Example 1 and Comparative Example 6, in Comparative Example 6, both the first negative electrode film and the second negative electrode film adopted the same negative electrode material with a high OI value, and the difference of OI₂−O₁ was 0. Although its energy density was comparable to that of Example 1, its cycling stability was lower than that of Example 1, and the capacity retention rate after 1000 cycles was only 87.62%.

As can be learned from the above comparisons, it was the special matching relationship between the positive and negative electrode materials in the disclosure that created the excellent energy density and cycling performance.

### Verification Example 2

After the batteries prepared from Example 1 to Example 2, Comparative Example 1, Comparative Example 2, and Comparative Example 6 were cycled 1000 times under the condition of a charging or discharging voltage of 1 C at 45° C., the negative electrode of the cell was dissembled and subjected to ICP test analysis. The results are shown in Table 4.

TABLE 4

| | Ni | Co | | Fe | | Mn | |
|---|---|---|---|---|---|---|---|
| First negative electrode film of Example 1 | / | / | | 190 | ppm | 540 | ppm |
| Second negative electrode film of Example 1 | 240 ppm | 90 | ppm | / | | 40 | ppm |
| First negative electrode film of Example 2 | / | / | | / | | 30 | ppm |
| Second negative electrode film of Example 2 | 630 ppm | 280 | ppm | / | | 110 | ppm |
| Negative electrode film of Comparative | / | / | | 230 | ppm | 770 | ppm |
| Example 1 | | | | | | | |
| Negative electrode film of Comparative | 430 ppm | 120 | ppm | / | | 50 | ppm |
| Example 2 | | | | | | | |
| First negative electrode film of Comparative | / | / | | 220 | ppm | 660 | ppm |
| Example 6 | | | | | | | |
| Second negative electrode film of | 580 ppm | 190 | ppm | / | | 80 | ppm |
| Comparative Example 6 | | | | | | | |

As can be learned from Table 4, the ICP test element distributions after cycling of the cells prepared from Example 1, Example 2, Comparative Example 1, Comparative Example 2, and Comparative Example 6 were also different. After 1000 cycles, Co and Ni were present on the negative electrode plate, which suggests that the material used in its positive electrode included nickel, cobalt and manganese.

The above-described specific embodiments have further detailed the objectives, technical solutions, and beneficial effects of the disclosure. It should be understood that the above descriptions only cover specific embodiments of the disclosure and are not intended to limit the disclosure. Any modifications, equivalent replacements, improvements, etc., made within the spirit and principle of the disclosure should be included within the scope of protection of the disclosure.

What is claimed is:

1. A cell, comprising a positive electrode plate and a negative electrode plate alternately arranged along a cell thickness direction, with a separator provided between the positive electrode plate and the negative electrode plate, wherein
the positive electrode plate comprises a positive electrode current collector, a first positive electrode film, and a second positive electrode film, and the first positive electrode film and the second positive electrode film are respectively arranged on two opposite surfaces of the positive electrode current collector, wherein the first positive electrode film comprises a first positive electrode active substance that comprises a phosphate material, the second positive electrode film comprises a second positive electrode active substance that has a gram capacity greater than a gram capacity of the first positive electrode active substance, and
the negative electrode plate comprises a negative electrode current collector, a first negative electrode film, and a second negative electrode film, and the first negative electrode film and the second negative electrode film are respectively arranged on two opposite surfaces of the negative electrode current collector, wherein the first negative electrode film comprises a first negative electrode active substance, the second negative electrode film comprises a second negative electrode active substance, and OI₂−OI₁>5 is satisfied, wherein OI₂ is an OI value of the second negative electrode film, and OI₁ is an OI value of the first negative electrode film.

2. The cell according to claim 1, wherein the first positive electrode film is adjacent to the second negative electrode film via the separator, and the second positive electrode film is adjacent to the first negative electrode film via the separator.

3. The cell according to claim 1, wherein a thickness ratio of the first positive electrode film to the second positive electrode film is (1.1 to 2.5):1.

4. The cell according to claim 1, wherein the first positive electrode active substance and the second positive electrode active substance satisfy one or more of conditions a to d below:
a. the phosphate material is lithium iron phosphate and/or lithium manganese iron phosphate;
b. the second positive electrode active substance comprises one or more of lithium manganate, lithium cobalt oxide, lithium nickelate, lithium nickel cobalt aluminum oxide, lithium nickel cobalt manganese oxide, and lithium-rich manganese-based materials;
c. a discharge gram capacity of the first positive electrode active substance at a current density of 0.1 C is 127 to 160 mAh/g; and
d. a discharge gram capacity of the second positive electrode active substance at a current density of 0.1 C is 180 to 210 mAh/g.

5. The cell according to claim 1, wherein the first positive electrode active substance and the second positive electrode active substance satisfy one or more of conditions e to g below:
e. based on a mass of the first positive electrode film, a mass content of the first positive electrode active substance is 92% to 97%;
f. based on a mass of the second positive electrode film, a mass content of the second positive electrode active substance is 94 to 98%; and
g. the mass content of the second positive electrode active substance is greater than the mass content of the first positive electrode active substance.

6. The cell according to claim 1, wherein the first negative electrode film and the second negative electrode film satisfy one or more of conditions a to c below:
a. the OI value OI₁ in the first negative electrode film is 2 to 15;
b. the OI value OI₂ in the second negative electrode film is 15 to 50; and
c. the OI₂−OI₁ is 5 to 15.

7. The cell according to claim 1, wherein the first negative electrode active substance and the second negative electrode active substance each independently comprise one or both of graphite and silicon materials.

8. The cell according to claim 1, wherein a thickness of the first negative electrode film and a thickness of the second negative electrode film satisfy at least one of conditions below:
a. the thickness of the first negative electrode film and the thickness of the second negative electrode film are the same as or different from each other; and
b. the thicknesses of the first negative electrode film and the second negative electrode film are 50 to 100 μm.

9. The cell according to claim 1, wherein, based on a mass of the first negative electrode film, a mass content of the first negative electrode active substance is 93 to 98%, and
based on a mass of the second negative electrode film, a mass content of the second negative electrode active substance is 95 to 98.5%.

10. An electronic device comprising the cell according to claim 1.
